(19) United States
(12) Patent Application Publication
(10) Pub. No.: US 2024/0207811 A1
(43) Pub. Date: Jun. 27, 2024

(54) Method for Carrying Out a Chemical Reaction and Reactor Arrangement

(71) Applicants: LINDE GMBH, Pullach (DE); BASF SE, Ludwigshafen (DE); SABIC Global Technologies B.V.

(72) Inventors: Mathieu Zellhuber, Martinsried (DE); Martin Hofstätter, München (DE); Kiara Aenne Kochendoerfer, Ludwigshafen (DE); Andrey Shustov, Ludwigshafen am Rhein (DE); Eric Jenne, Hassloch (DE); Andrea Haunert, Ludwigshafen (DE); Scott A. Stevenson, Houston, TX (US); Robert R. Broekhuis, Sugar Land, TX (US); Andrew M. Ward, Yorkshire (GB)

(21) Appl. No.: 18/554,246

(22) PCT Filed: Apr. 7, 2022
(86) PCT No.: PCT/EP2022/059330

§ 371 Date: Oct. 6, 2023

(30) Foreign Application Priority Data
Apr. 7, 2021 (EP) 21167191.2

(51) Int. Cl. B01J 19/24; B01J 3/00

(52) U.S. Cl. CPC B01J 19/243; B01J 3/00; B01J 2219/00121; B01J 2219/00132; B01J 2219/00981

(57) ABSTRACT

A method for carrying out a chemical reaction includes using a reactor arrangement in which reaction tubes arranged in a reactor vessel are heated to a reaction tube temperature level between 400° C. and 1,500° C. during a reaction period using radiant heat provided by means of one or more electric heating elements arranged in the reactor vessel. In at least a part of the reactor vessel in which the heating elements are provided, a gas atmosphere is provided during the reaction period, which gas atmosphere has a defined volume fraction of oxygen.

### CROSS-REFERENCE TO RELATED APPLICATIONS

This application is the national phase of, and claims priority to, International Application No. PCT/EP2022/059330, filed Apr. 7, 2022, which claims priority to European Patent Application No. EP21167191.2, filed Apr. 7, 2021.

### FIELD OF THE INVENTION

The invention relates to a process for carrying out a chemical reaction and to a corresponding reactor arrangement.

### BACKGROUND

In a number of processes in the chemical industry, reactors are used in which one or more reactants are passed through heated reaction tubes where they are catalytically or non-catalytically reacted. The heating serves in particular to overcome the activation energy required for the chemical reaction to take place and, in the case of endothermic reactions, to provide the necessary energy for the chemical reaction. The reaction can proceed endothermically overall or, after overcoming the activation energy, exothermically. The invention relates in particular to strongly endothermic reactions as further discussed below.

Examples of such processes are steam cracking, various reforming processes, in particular steam reforming, dry reforming (carbon dioxide reforming), mixed reforming processes, processes for the dehydrogenation of alkanes and the like. In steam cracking, the reaction tubes are guided through the reactor in the form of coils, which have at least one reverse bend in the reactor, whereas in steam reforming, tubes are typically used which run through the reactor without a reverse bend. The invention also may be used in connection with so-called “millisecond” or single-pass reactors which are characterized by very low dwell times.

Further applications of the invention are reactors for performing a reverse water gas shift (RWGS) reaction of carbon dioxide and hydrogen to form carbon monoxide and water, a dehydrogenation of oxygenates such as a reaction of methanol to formaldehyde and hydrogen, cleavage of ammonia to yield gaseous nitrogen and hydrogen, dehydrogenation of so-called liquid organic hydrogen carriers (LOHC) as known to the skilled person, and reforming of methanol and glycerol (as far as not already included by the term “reforming” used above).

The invention is suitable for all such processes and embodiments of reaction tubes. Purely by way of illustration, reference is made to the articles “Ethylene”, “Gas Production” and “Propene” in Ullmann's Encyclopedia of Industrial Chemistry, for example the publications dated Apr. 15, 2009, DOI: 10.1002/14356007.a10_045.pub2, Dec. 15, 2006, DOI: 10.1002/14356007.a12_169.pub2, and Jun. 15, 2000, DOI: 10.1002/14356007.a22_211.

The reaction tubes of corresponding reactors are conventionally heated by using burners. The reaction tubes are, for this purpose, guided through a combustion chamber in which the burners are also arranged.

Currently, however, demand is increasing for synthesis products such as olefins, but also for synthesis gas and hydrogen, which are produced with no or reduced local carbon dioxide emissions. This demand cannot be met by processes using fired reactors due to the use of typically fossil fuels. Other processes are practically excluded due to high costs, for example.

It has therefore been proposed to support or replace the burners in corresponding reactors by electrical heating means. In addition to direct electrical heating, in which current is applied to the reaction tubes themselves, for example in a known star (point) circuit, and other types of heating, which are not explained in detail here, concepts also exist in particular for so-called indirect electrical heating. This is also used in the context of the invention. Irrespective of the specific type of heating and the heating concept implemented in the process, appropriately heated reactors are also referred to as “furnaces”.

Such indirect electrical heating can be carried out, as explained e.g. in WO 2020/002326 A1, using electrically operated radiative heating elements (“radiant heaters”) suitable for heating to the high temperatures required for the reactions mentioned, such heating elements being arranged within the furnace in such a way that they are not in direct contact with the reaction tubes. The heat transfer takes place predominantly or exclusively in the form of radiant heat. Therefore, the terms “indirect heating”, “heating by means of radiant heat” and the like are used synonymously below. Properties of corresponding heating elements are explained below.

The invention has an object of providing measures which permit advantageous operation of a reactor of the type explained which is indirectly electrically heated using appropriate heating elements.

### SUMMARY

According to an embodiment of the invention, a method for carrying out a chemical reaction includes using a reactor arrangement in which reaction tubes arranged in a reactor vessel are heated to a reaction tube temperature level between 400° C. and 1,500° C. during a reaction period using radiant heat provided by means of one or more electric heating elements arranged in the reactor vessel. In at least a part of the reactor vessel in which the heating elements are provided, a gas atmosphere is provided during the reaction period, which gas atmosphere has a defined volume fraction of oxygen.

### BRIEF DESCRIPTION OF THE DRAWINGS

FIGS. 1 to 4 schematically illustrate reactor arrangements for carrying out a chemical reaction according to one embodiment of the invention.

FIG. 5 schematically illustrates basic principles of a stack dimensioning according to one embodiment of the present invention.

FIGS. 6A to 6D schematically illustrate examples of pressure flap arrangements according to embodiments of the present invention.

### DETAILED DESCRIPTION OF THE INVENTION

The invention relates to a process for carrying out a chemical reaction, in which a reactor arrangement is used in which reaction tubes arranged in a reactor vessel are heated during a reaction period using radiant heat provided by means of one or more electrical heating elements arranged in the reactor vessel. Heating is performed to reach a temperature level, hereinafter referred to as the “reaction tube temperature level”, of between 400° C. and 1,500° C., in particular between 450° C. and 1,300° C., further in particular between 500° C. and 1,200° C. and yet further in particular between 600° C. and 1,100° C., particularly at a reaction tube surface and/or within the reaction tubes. During the reaction period, one or more combustible components are passed through the reaction tubes. The reaction tube temperatures can be selected to be identical or comparable to those selected for fired furnaces or other electrically heated furnaces. They cover comparatively wide temperature ranges, since a not inconsiderable temperature gradient always occurs in corresponding reaction tubes (“cold” inlet and “hot” outlet, especially with increasing coking). The provision of the above reaction tube temperature levels requires even higher heating element temperatures when radiant heating elements are used.

The invention can be used, as mentioned, in particular in connection with the production of olefins and/or other synthesis products by steam cracking or in connection with the production of synthesis gas or hydrogen by steam reforming, as mentioned at the outset. However, the invention is suitable in principle for all types of reactions in which a feed mixture is passed in a gaseous state through reaction tubes heated from the outside to appropriate temperature levels and is thereby reacted.

The reaction tubes can be guided through the reactor vessel in any way conceivable, in particular with or without one or more reverse points or reverse bends. In particular, they can be arranged in a single row in a vertically arranged plane and heated by means of radiation heating elements arranged on both sides of the plane. A multi-row arrangement in an intermediate area between two planes and corresponding heating from outside the intermediate area is also possible. In particular, the reaction tubes have a length of 5 to 100 m and/or a diameter of 20 to 200 mm. Furthermore, the individual reaction tubes can be designed in sections in two or more parallel strands with reduced tube diameters as compared to a single tube. Preferably, the multi-strand section is arranged close to the entry into the furnace in order to provide the highest possible length-specific reaction tube wall area in this region. Further downstream in this arrangement, the initially parallel strands are combined into a common strand with a preferably larger tube diameter. In this example, the reaction tube consists of the two or more parallel strands, the junction, particularly including a connection fitting, and the united strand. Conversely, it is also possible in principle to provide a multi-strand design of the reaction tube at the end or in the middle section, with intermediate dividing and, if necessary, additional joining pieces. Generally, tubes may be split and combined in embodiments of the invention in any conceivable manner. The reaction tubes can also be filled with a suitable catalyst material and/or an inert material or may be provided in an empty form, depending on the type of reaction.

The invention provides for heating of the reaction tubes using electrically provided radiant heat. However, this does not preclude the use of other types of heating in addition, for example, direct heating in which the reaction tubes themselves are used as electrical resistors to generate heat, inductive heating or, in further reactor vessels of the reactor arrangement, heating using burners. In either case, in addition to radiant heat, some of the heat provided by means of an appropriate heating element may also be convectively transferred to the reaction tubes.

Therefore, if reference is made here to the use of indirect electrical heating, i.e. the use of radiant heat provided by means of electrical heating elements, this does not exclude the presence of additional electrical or non-electrical heating. In particular, it may also be envisaged to vary the contributions of the types of electrical and, in particular, non-electrical heating over time, for example as a function of the supply and price of electricity or the supply and price of non-electrical energy sources.

A “reactor vessel” is understood here to mean an enclosure which is partially or completely thermally insulated from the outside and which can in particular be lined with a material which is thermally resistant at the temperatures mentioned. The reactor vessel is in particular surrounded predominantly, i.e. to at least 90%, 95%, 99%, 99.5% or 99.8%, by (solid) wall having thermally insulating properties. These walls may comprise a tight, continuous or impervious backlayer, such as a metallic sheet, and one or more insulation layers. The figures given for the proportion in which the reactor vessel is “surrounded by a thermically insulating wall” may, in this connection, particularly be understood as a proportion of overall housing of the reactor vessel which is made up of solid structures having thermally insulating properties, i.e. which are cladded with, or made from or include, a thermally insulating material. Openings or ports of the reactor housing, which are typically not provided as being fully thermally insulating, may not be included in the figures given for the “predominantly surrounded” reactor vessel. Any part of the reactor wall which is, as understood herein, provided as being “thermally insulating” may have a thermal transmittance below 2 W/m²K, particularly below 1.5 W/m²K, below 1 W/m²K, below 0.5 W/m²K or below 0.2 W/m²K. The term “thermal transmittance” is intended to express that the value indicated by the associated figure refers (only) to the conductive heat transfer coefficient in the solid structure (particularly excluding radiative and convective heat transfer components on the inside and outside of the wall). For example, if the reactor vessel is surrounded to at least x % by the thermally insulating wall, as indicated above, these x % of wall area or less may be configured to have a thermal transmittance as just indicated. As mentioned, openings or ports of a reactor housing may not be thermally insulated accordingly and therefore their thermal transmittance may be higher, or, e.g. in case of permanent openings, they may not represent any thermal barrier at all. To provide a reactor wall in a thermally insulating configuration, the wall may, as mentioned, be made up of, include, or be cladded with, a thermally insulating material such as, but not limited to, ceramic fibers, heat-reflecting metal foils, minerals, and expanded polymers or any combination thereof. Different thermally insulating materials may be provided, particularly in correspondence with local temperatures present and with different thermal resistances.

As mentioned, the invention is not limited to the use of exactly one reactor vessel, but can in particular also be used in arrangements with differently heated reactor vessels. Further details on corresponding reactor vessels and their equipment with gas feed devices and, if applicable, gas extraction devices and their connection to stacks and the like are explained further below. Herein, the terms (exiting) “stack” and “chimney” are used as synonyms and both relate to a structure with a (main) function of providing a fluid connection to a safe outlet location, e.g. to the atmosphere, preferably at sufficient height from the ground.

In the context of the invention, a reactor vessel need not be designed to be gas-tight, or at least not completely gas-tight. According to embodiments of the invention, the reactor vessel is particularly provided as being sufficiently gas tight to be able to practically control the oxygen level inside the vessel. As mentioned herein, a defined oxygen concentration is particularly advantageous at the heating elements and therefore the gas tightness of the reaction vessel is particularly relevant in proximity thereof. Therefore, the walls of the reactor vessel may be provided in a lower gas tightness in proximity to the heating elements. This is, however, not provided in all embodiments of the invention. For the avoidance of doubt, the gas tightness may not pertain to any purposely introduced gas, even if this gas flows under the influence of a pressure differential between the outside and the inside, i.e. across a wall, of the reactor vessel.

A “reaction period” is understood here to mean a period of time or a partial period of a corresponding period of time during which the reaction carried out takes place and during which the reactants required for the reaction are passed through the reaction tubes. Typically, during a reaction period, flammable components, in particular hydrocarbons, are contained in the process feed gas and are therefore passed through the reaction tubes. In periods other than the reaction period, such as in regeneration periods or inertization periods, such flammable components are typically not passed through the reaction tubes.

As is generally known, processes of the type explained can in particular also include a decoking operation in which deposits formed in the reaction tubes after a corresponding reaction period are removed, for example by “burning off” by means of an oxygen-containing gas or gas mixture. This is particularly the case in pure gas phase reactions without the use of a catalyst. Before a corresponding decoking operation, the reaction tubes are typically freed from the reactants and, in particular, a preliminary cooling or subsequent heating is carried out. Corresponding periods of a decoking operation, but also, for example, of a standby operation with pure steam addition into the reaction tubes to avoid (excessive) cooling (so-called “hot-steam standby operation”) and periods of cooling or heating do not count in the understanding used here as part of the reaction period, nor do, for example, maintenance periods or periods in which a catalyst bed is replaced or regenerated.

According to the invention, at least in a part of the reactor vessel in which the heating elements are provided, and at least during the reaction period during which said flammable components are passed through the reaction tubes, or during a part of said reaction period, a gas atmosphere is provided in the reactor vessel. The gas atmosphere comprises, in particular in addition to one or more known inert gases such as nitrogen or carbon dioxide or one or more noble gases such as argon, a volume fraction of oxygen adjusted between 500 ppm and 10%, particularly between 1,000 ppm and 5% or between 5,000 ppm and 3%. Herein, the lower value may be used to define a lower threshold and the upper value may be used to define an upper threshold for a (feed-back) control structure implemented in a control device or system adjusting the oxygen volume fraction.

In summary, the invention proposes to provide a gas atmosphere comprising controlling oxygen in a “sweet spot” window, in which both safety and element longevity criteria are met, as further explained below, during the reaction period. In periods other than the reaction period, i.e. during periods where preferably no flammable components are passed through the reaction tubes, an oxygen content outside of this window can be used or, in other embodiments, the same oxygen content can be used.

By maintaining a volume fraction oxygen content between limit values according to embodiments of the invention, the durability of corresponding heating elements can be increased on the one hand and a high level of operational safety can be ensured on the other.

The heating elements used for indirect heating of corresponding reaction tubes typically comprise electrically conductive, metallic or non-metallic heating structures in a given shape of, for example, straight or otherwise shaped rods, wires or strips, wherein the metallic heating structures can preferably be formed in particular from an alloy containing at least the elements Fe, Cr and Al. Alternatively or additionally, metallic heating structures can also be formed at least partially from nickel-chromium alloys, copper-nickel alloys or nickel-iron alloys.

It has been found that for the indirect heating of reaction tubes, especially in steam cracking, extremely high heat flux densities at high temperatures are required for economical operation, so that the heating elements or the heating structures must be operated near their upper temperature limit. However, it is precisely near this limit that the heating elements and heating structures are highly sensitive to the furnace atmosphere. In particular, a certain minimum oxygen content is advantageous in order to avoid or slow down rapid or gradual deterioration of the heating elements or the heating structures. For example, when using metallic heating structures containing aluminum, a stable aluminum oxide layer forming on the surface of the heating structures, which protects the material from uncontrolled corrosion and other damage mechanisms, can be maintained. The invention therefore effects a long durability of the heating elements or of their heating structures by using an appropriate minimum oxygen content.

It has been found that FeCrAl based heating elements are damaged by exposure to atmospheres containing high concentrations of nitrogen and low concentrations of oxygen at high temperatures and thus have lower maximum operating temperatures in such atmospheres compared with their permitted maximum operating temperatures in air. Without being bound by theory, this damage is thought related to the formation of nitrides which interferes with the formation of the protective aluminium oxide layer on the element surface and causes corrosion which can significantly reduce heating element life. The degree and speed at which such damage can occur relates to the concentration of oxygen and oxygen containing species in the atmosphere in contact with the heating element as well as the element temperature. For example, research as documented in J. Min. Metall. B 55, 2019, 55, has shown that heating FeCrAl material to 1,200° C. in an atmosphere of 99.996% nitrogen (impurity level of oxygen and water below 10 ppm) resulted in a progression of corrosion which takes place through the formation of localized subsurface nitridation regions composed of AlN phase particles. Conversely, as documented in Surf Coat. Technol. 135, 2001, 291, for FeCrAl alloys no significant morphological differences among the oxide scales obtained by oxidation in air or in gaseous atmospheres containing 2 or 10% vol. of oxygen were observed.

Again without being bound by theory and not limiting the scope of the invention, the oxygen concentration required at the surface of the heating element to prevent accelerated deterioration of the element is believed to depend on operating conditions such as temperature, as well as the thermal history of the heating element, which determines the thickness and quality of any protective oxide layer. While a quite low oxygen concentration (e.g., 100 ppm) may suffice to prevent accelerated deterioration in favourable circumstances, it is prudent to target a higher oxygen concentration in the furnace atmosphere, to account for situations in which the heating element surface is more vulnerable to nitridation and also to account for a non-uniform distribution of oxygen through the furnace, which may result in its concentration being locally below the targeted concentration. Therefore, a practical lower limit to the oxygen concentration in the furnace or reactor vessel atmosphere appears to be 0.1% oxygen by volume, but also 500 ppm may be selected. Higher limit concentration values, such as 0.2% oxygen by volume or more, such as 0.5% by volume, may provide an additional margin of safety at less favourable furnace conditions or more pronounced maldistribution of oxygen, and may be selected in accordance with this invention. Conversely, as long as a minimum oxygen concentration to prevent nitride corrosion is satisfied, low oxygen concentration in the vicinity of the heating elements may be beneficial, as it is known that the rate of oxidation of typical heating element materials increases with the oxygen concentration. The minimum oxygen concentration may depend on the temperature and also the composition of the heating elements.

The provision of the gas atmosphere provided according to the invention is advantageous in connection with the metallic alloys mentioned, but also in principle for use in connection with other materials, for example based on MoSi2 or SiC, irrespective of the damage effect to be observed in each case.

An important consideration in determining the maximum amount of oxygen allowed is the flammability limits of the feed and product gases. On the flammability envelope of all combustible gases there is an oxygen concentration, commonly referred to as the Limiting Oxygen Concentration (LOC), below which a flammable mixture cannot be formed. For example, the LOC of ethylene at 25° C. and 1 atm is 10% oxygen. At these conditions, any mixture of ethylene, nitrogen, and oxygen that does not contain at least 10% oxygen cannot generate a self-propagating flame. Combining literature data with a temperature adjustment procedure, the LOCs of ethane and ethylene at a typical steam cracking temperature of 830° C. can be estimated to be 4.1% and 3.6%, respectively. If the oxygen concentration in the reactor vessel is such that it is lower than these limits, a flammable mixture will not be formed in the event of a coil rupture.

While there are some uncertainties to calculate the same limit for a complex mixture like naphtha, estimates include 4.2% for the LOC for hexane, so ethylene is expected to be the reactant/product with the lowest LOC. While 830° C. is above the autoignition temperature of all of these hydrocarbons, even if there is spontaneous combustion, staying below the LOC is expected to prevent a shockwave from forming.

On the basis of these observations, the oxygen levels according to the invention are proposed.

In general, the heating elements used in the context of the invention can have a base body formed, for example, from an electrically non-conductive, heat-resistant material (e.g. ceramic), on or in which the heating structures, for example in the form of heating wires or heating ribbons, are guided e.g. in a meandering manner. Alternatively, one or more straight and/or curved heating structures with a holder associated with the heating element can also be used. For example, so-called heating cartridges can be used, which can be fixed in suitable connections by means of plug-in or bayonet connections and the like. Typically, a multiphase alternating current (AC), in particular a three-phase alternating current, is used for heating, and the heating wires can be connected in groups to the phases of a corresponding alternating current, but also direct current (DC) heating may be used. The invention permits any grouping, arrangement, and mode of operation of corresponding heating elements and is not limited thereby.

In the context of the invention, corresponding heating elements can be arranged in particular on the walls of the reactor vessel and radiate heat from there to the reaction tubes. The walls may be straight or curved, e.g. in the form of parabolic surfaces. The walls can have a combination of any wall shapes and also, for example, straight wall sections that can be arranged at an angle or at any angle to one another. The provision of the gas atmosphere according to the invention ensures that the oxygen contents mentioned prevail in the areas where the heating elements are arranged.

The invention results in increased operational safety for corresponding reactor vessels due to the proposed upper oxygen limit, in particular in the event of damage to the reaction tubes (“coil ruptures”). In the event of corresponding damage, one or more reaction tubes can be severed, in particular completely; however, the invention is also advantageous for leakages on a smaller scale. In the event of corresponding damage, there is a sudden or gradual escape of combustible gas into the reactor vessel, which is largely sealed off for thermal insulation reasons.

Such damage is less of a safety problem in conventional fired reactors than in arrangements according to the invention, in which at least one reactor vessel is heated exclusively electrically, since in fired reactors combustible gases escaping from the reaction tubes, for example in the form of a hydrocarbon/steam mixture, can be converted in a controlled manner by the combustion taking place in the reactor vessel or in a corresponding combustion chamber, or can be safely discharged in the exhaust gas flow. Furthermore, since the combustion of fuel gas, which is already taking place in a regular manner, results in a significantly reduced oxygen content, the gas chamber surrounding the reaction tubes is thus already essentially “inertized”. In contrast, in the case of purely electrical heating, corresponding combustible gases could accumulate in the reactor vessel and reach the explosion or detonation limit there at the normal oxygen content of the air and temperatures above the auto-ignition temperature, for example. Even in the case of combustion without explosion or detonation, complete or incomplete combustion results in an energy release and thus possibly in overheating. Complete or incomplete combustion, together with the volume of gas flowing out of the reaction tubes, can lead in particular to an undesirable increase in pressure. The invention reduces such an increase in pressure because the burnup of the gas mixture is limited by the low oxygen concentration, and therefore, the low oxygen inventory, in the reactor chamber.

Thus, the invention is particularly preferred for indirectly electrically heated reactors in which the process gas temperature is close to or above the auto-ignition temperature of components contained in the process gas, particularly hydrocarbons.

By means of the proposed measures, the invention creates a containment with a conditioned atmosphere which serves for the maintenance of a protective oxide surface on the heating elements and for the safety-related protection of high-temperature reactors in which the energy input takes place electrically. Within the scope of the invention, in particular, a completely electrical heating of the correspondingly operated reactor vessel may be provided, i.e., the heating of the reaction tubes, at least within this reactor vessel, is advantageously carried out predominantly or exclusively by electrical heating, i.e., at least 90, 95 or 99% of the heat quantity introduced here, in particular of the entire heat quantity introduced here, is carried out by electrical heating means. Heat input via a gas mixture passed through the one or more reaction tubes is not taken into account here, so that this proportion relates in particular to the heat transferred inside the reactor vessel from outside to the wall of the one or more reaction tubes or generated inside the reactor vessel in the wall or a catalyst bed.

In certain embodiments of the invention, hereinafter also referred to as the “first group of embodiments”, one or more gases or gas mixtures used to provide the gas atmosphere can be fed into the reactor vessel, while at the same time part of the gas atmosphere is exported from the reactor vessel. This results in particular in a continuous flow through the reactor vessel, so that in this way also, for example, a heat accumulation or a local enrichment or depletion of gaseous components can be avoided. In this way, it is particularly easy to control the oxygen content in the gas atmosphere by adjusting the feed accordingly.

In this first group of embodiments, one or more outflow openings (hereinafter the singular is used in part only for simplification) from the reactor vessel, which in particular can establish a connection with a stack, for example an emergency stack, is or are permanently open. By this is meant that the one or more outflow openings do not oppose any mechanical resistance to the outflow or inflow of fluid into or out of the reactor vessel, except for the possibly existing constriction of the flow cross-section. Thus, the one or more openings is or are unsealed at least during the reaction period.

In this case, a stack opening or a connection to the stack or another outflow opening also serves to discharge excess gas or, in particular, combustible hydrocarbons in the event of damage to the reaction tubes. In this case, a stack can have constructive elements (so-called velocity seals or confusers), especially in the area of the stack wall, to prevent backflows (e.g. due to free convection currents) back to the reactor vessel.

In other embodiments, hereinafter also referred to as the “second group of embodiments”, an outflow opening or several outflow openings from the reactor vessel (hereinafter the singular is used in part only for simplification), in particular a stack opening or a connection to the stack, can be designed to open only above a predetermined pressure level, for example by closing the outflow opening via a pressure flap or a bursting disc or corresponding valves. In this case, the outflow opening is normally closed, i.e. below the predetermined pressure level, but serves for the discharge of excess gas or, in particular, combustible hydrocarbons in the event of damage to the reaction tubes, in the event of a corresponding pressure increase by the release of a corresponding stack cross-section. In this case, a temporary or permanent opening can be provided when the predetermined pressure level is reached. In this context, a “permanent” opening is understood to mean, in particular, an irreversible opening, so that in this embodiment no resealing takes place after the pressure subsequently falls below the predetermined pressure level by releasing gas. In the case of a “temporary” opening, on the other hand, a reclosure takes place.

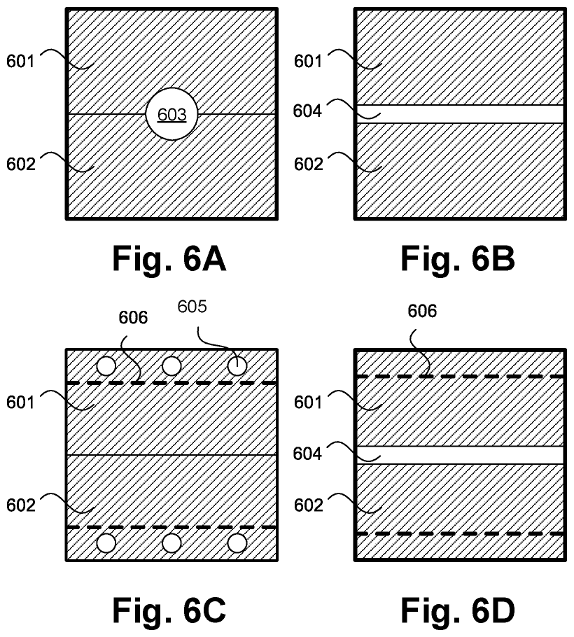

For opening at the predetermined pressure level, the one or more outflow openings can, for example, have one or more spring-loaded or load-loaded flaps which have an opening resistance defined by the spring or load characteristics and therefore only open at a corresponding pressure, or, more precisely, a pressure differential across the opening. Examples of suitable flap configurations for a rectangular duct opening are discussed in connection with FIGS. 6A to 6D below. In cases where the axis of rotation of the flap is offset from the duct wall the pressure increase at which the flap opens can be tuned by adjusting the thickness and/or density of the material on either side of the axis. Similar configurations can be used for circular duct openings.

In addition to the aforementioned use of bursting discs or (mechanical) pressure relief valves known per se, it is also possible to detect a pressure value, for example by sensor, and to trigger an opening mechanism of any type, for example an ignition mechanism or an electro-actuator drive, when a predefined threshold value is exceeded. This makes it possible to create an opening with a sufficiently large cross-section within a short response time if necessary, which is kept closed in the explained manner during normal operation.

In this case, i.e. in the second group of embodiments, the stack opening, which is closed during normal operation, can be bypassed via a corresponding bypass line opening into the stack in order to remove the gas atmosphere or to flush the reactor vessel. In this way, by using fluid-technical devices in the bypass line, a particularly controlled and, for example, time-controlled withdrawal is possible.

Generally, withdrawal of gas from the reactor chamber is possible to effect a change in the composition of the gas atmosphere and/or a cooling. Gas withdrawn from the reactor chamber can be cooled and/or regenerated in order to be used again (recycled) for providing the gas atmosphere. In the course of cooling, a heat integration can be performed, i.e., particularly in a heat exchanger, heat withdrawn from the gas may be transferred to a further stream and/or steam in a steam system.

For feeding the one or more gases or gas mixtures used to provide the gas atmosphere, gas feed means provided in the form of feed nozzles or feed openings or comprising such means can be provided and used, as well as a gas reservoir connected thereto. These can in particular be designed to be controllable by known means of fluid technology.

The feed and/or extraction can be carried out continuously or discontinuously, in particular in accordance with a control based on a desired oxygen content to comply with the first and second limit values used in accordance with the invention.

In other words, in the context of the invention, a continuous or discontinuous feed of one or more gases or gas mixtures used to provide the gaseous atmosphere may be made into the reactor vessel, and a withdrawal of at least a portion of the gaseous atmosphere from the reactor vessel may further be made, wherein the withdrawal may be made at least partially simultaneously with or at least partially delayed from the feed.

Within the scope of the invention, a sub-atmospheric pressure level can be provided in the reactor vessel. This can be brought about, in particular, in the case of simultaneous feed and withdrawal in the manner explained and, in particular, by coordinating the feed and withdrawal in the case of an embodiment with a permanently open connection from the reactor vessel to the (emergency) stack or other measures previously provided in connection with the first group of embodiments. In this case, due to the high temperatures in the stack and reactor vessel and the resulting lower density of the contained gas volume, a static negative pressure results in the reactor vessel. The use of (“sucking”) fans inducing a draft, for example until a corresponding static negative pressure is formed, can also be provided in this context.

By operating the reactor vessel at a subatmospheric pressure level, an outflow of possibly harmful, corrosive or combustible undesirable components from the reactor vessel can always be reliably prevented. However, an inflow of air or secondary air may occur, but this can be limited by a sufficiently tight design and/or compensated for by appropriate control.

Consequently, when operating the reactor vessel at a subatmospheric pressure level, the walls of the reactor vessel are preferably provided in a particularly high gas tightness to prevent uncontrolled air and therefore oxygen ingress into the reactor vessel. In an embodiment, the furnace walls are built such that the relative air ingress rate per furnace inner wall surface area and per average pressure difference (as an absolute value) between the reactor vessel interior and the surrounding outside atmosphere (at same altitude) is limited to values below 0.5 Nm³/(h×m²×mbar), below 0.25 Nm³/(h×m²×mbar) or below 0.1 Nm³/(h×m²×mbar), where Nm³ are normal cubic metres at 0° C. and atmospheric pressure. The furnace inner wall surface area is defined here as the sum of the hot surface areas of the thermal box or reactor vessel insulation delimiting the inner box volume in all directions (i.e. on the sides, top and bottom), without including the surface area of radiative heating elements or other structures protruding from the thermal insulation into the inner box volume. These values are selected such as to enable moderate inert gas feed rates (to minimize utility consumption and convective heat losses through the stack) while maintaining the resulting oxygen concentration in the reactor vessel interior below the defined upper limit. In a preferred embodiment, the average pressure difference (as an absolute value) between the reactor vessel interior and the surrounding outside atmosphere (at same altitude) is below 10 mbar, below 5 mbar or below 3 mbar, depending mostly on the stack design (e.g. height, diameter, insulation) and the optional provision of fans or similar devices. As general design rules, the tightness of the reactor vessel walls is preferentially increased when a lower value of the upper oxygen limit is defined and/or when operating costs are to be minimized and/or when the absolute pressure difference over the walls of the reactor vessel toward the environment is increased.

In an alternative, however, which can be used in particular in connection with the aforementioned second group of embodiments, a superatmospheric pressure level can also be set in the reactor vessel. Thus, a superatmospheric pressure level can preferably be provided if a stack opening to the reactor vessel is closed or formed for an opening only above a predetermined pressure level, as explained.

In particular, the gas atmosphere can be provided by feeding one or more gases or gas mixtures used to provide the gas atmosphere into the reactor vessel without, however, simultaneously removing part of the gas atmosphere from the reactor vessel, as in the embodiment just explained. In this case, corresponding gases or gas mixtures can be injected up to a superatmospheric pressure level which, however, is below an opening pressure of the mentioned and above explained outflow openings. A corresponding design enables in particular a reduction of the required gas quantities, since advantageously the gas atmosphere can be fed in only at the beginning or intermittently during the reaction phase and then maintained without further measures.

However, a superatmospheric pressure level can also be set in an embodiment with feed of gases or gas mixtures to provide the gas atmosphere and simultaneous withdrawal of part of the gas atmosphere from the reactor vessel, preferably by providing an appropriately controlled and/or dimensioned bypass line which ensures a corresponding pressure level in the reactor vessel. Reference is made to the above explanations. In other words, a superatmospheric pressure level can be set in the reactor vessel even with a permanently open outflow opening or, for example, an outflow opening with adjustable flow rate, if the gas quantity fed in and/or the gas quantity flowing out via the outflow opening is adjusted accordingly.

If a superatmospheric pressure level is provided in the reactor vessel, in particular by a controlled feed, an inflow of outside air which increases the oxygen content in an uncontrolled manner can be prevented. In this embodiment, a measurement of the oxygen content after the initial conditioning has been carried out may be unnecessary, since there is no possibility of subsequent increase.

Herein, the term “subatmospheric pressure level” shall refer to any pressure below the standard atmospheric pressure of 101.325 Pa, particularly at least 10, 50, 100 or 200 mbar below this pressure. Correspondingly, the term “superatmospheric pressure level” shall refer to any pressure above the standard atmospheric pressure of 101.325 Pa, particularly at least 10, 50, 100 or 200 mbar above this pressure.

In embodiments of the invention, a wall of the reactor vessel does not comprise inspection ports for visual inspection of an inner space of the reactor vessel that are open to the atmosphere, or only comprises inspection ports for visual inspection of the inner space of the reactor vessel which are gas-tightly closed by a transparent material, particularly a heat-resistant transparent material. That is, in embodiments of the invention, particularly no heat and/or gas leaks are provided in the reactor walls in the form of (open) inspection ports, such that the gas atmosphere in the reactor may be adjusted in a particularly controlled manner. In embodiments, glazed and sealed viewing windows, i.e. inspection ports for visual inspection of the inner space of the reactor vessel which are gas-tightly closed by a transparent material are provided. The windows are preferably equipped on the outside with movable heat-insulated covers or blinds, which limit heat losses when the windows are not used for observation. In embodiments of the invention, cameras may be provided which allow observation of the reaction tubes but are installed in a way that a gas-tight seal is maintained, i.e. behind transparent windows or inside the reactor. In the latter case, any cabling may be passed through the reactor wall through gas tight ports.

In embodiments of the invention, open ports in the wall of the reactor may be dispensed with particularly because electrical heating reduces or obviates the need of monitoring the temperatures of the reaction tubes because heat is provided in a much more controlled manner in comparison to burners.

Recapitulating the above explanations, the gas atmosphere may be provided by injecting one or more gases or gas mixtures used to provide the gas atmosphere into the reactor vessel without performing a simultaneous withdrawal of a portion of the gas atmosphere from the reactor vessel or while performing a simultaneous withdrawal of a portion of the gas atmosphere from the reactor vessel.

Merely for the sake of clarification, it should be emphasized once again that operation at a sub-atmospheric pressure level can be carried out in particular if there is a (comparatively) large-area connection (i.e. low flow-related pressure loss) between the reactor vessel and a stack outlet and a sufficiently high stack is filled with hot (i.e. light) gas. In this case, the flow-induced pressure drop is less than the geodetic pressure difference between hot gas and cold outside air that results over the height of the stack, resulting in a negative pressure difference between the inside gas atmosphere and the outside atmosphere at the same geodetic height. Also, as mentioned, a blower can be used to provide a sub-atmospheric pressure level. A blower can be provided in the main stack line as well as in a bypass line.

Conversely, a superatmospheric pressure level results in particular if the connection between the reactor vessel and the stack outlet (during regular operation) is completely closed or reduced in size, for example via a bypass line, in such a way that the pressure loss is greater than the geodetic pressure difference between hot gas and cold outside air resulting over the height of the stack or the bypass line.

Thus, in the first and second groups of embodiments, the invention can be carried out with a subatmospheric or superatmospheric pressure level in the reactor vessel. In the first group of embodiments, a sub-atmospheric pressure level can preferably be provided by appropriately dimensioning and locating the outlet openings and/or using a blower.

According to a particularly advantageous embodiment, the process according to the invention comprises using a plurality of gases or gas mixtures to provide the gas atmosphere, these comprising a first gas or gas mixture with a first volume fraction of oxygen and a second gas or gas mixture with a second volume fraction of oxygen below the first volume fraction. These can be used as explained below.

In one embodiment of the invention, it can be provided that at least part of the first gas or gas mixture is fed into at least one first region of the reactor vessel, whereas at least part of the second gas or gas mixture is fed separately therefrom into at least one second region of the reactor vessel. This embodiment makes it possible, in particular, to adjust the spatial distribution of the oxygen content in a particularly advantageous manner depending on local requirements. It can also be provided that the feed into the first and second areas takes place simultaneously, and in particular also in adjustable quantities in each case, or not simultaneously. For example, at least temporarily, the gas or gas mixture can be fed into only one of the areas, for example if at a subatmospheric pressure level an air intake (and thus the inflow of oxygen) is so high that only nitrogen or another inert gas is to be fed in. A defined air intake can also be ensured, e.g. via adjustable or non-adjustable inflow openings such as ventilation slots or flaps or closable holes. Corresponding inflow openings can be designed to be openable, in particular in variable number or with adjustable flow cross-section, in order to be able to adjust the amount of inflowing ambient air in this way. A corresponding adjustment of the inflow can thereby be understood in the sense of the invention as a further defined feed of a gas mixture, namely the ambient air.

A permanent feed of a gas or gas mixture (premixed or not, as explained below) into only one area is also possible in this context (for example, by feed means provided only at certain points on the reactor wall, or also inlet openings for air, as just explained). A feeding “into” the corresponding area or areas is done in such a way that the corresponding gas or gas mixture (or the respective portion) reaches these area(s), for example below or laterally thereof, so that by a defined flow in the reactor vessel, due to thermal effects, or solely by an inflow impulse, the gas or gas mixture flows there. Feeding within these areas is also possible. In another embodiment of the invention, however, clean “instrument” air is used instead of air leaking into the reactor. Advantages of using clean air include that less dust, moisture, and possible contaminants which could affect element lifetimes are introduced.

In particular, the heating elements can be arranged in the at least one first area and the reaction tubes in the at least one second area of the reactor vessel. By the explained gas feed or also an intake of ambient air, in particular a relative increase of the oxygen content in the region of the heating elements (to avoid aging/damage in the explained manner) and a relative reduction of the oxygen content in the region of the reaction tubes (to minimize the reaction conversion of possibly escaping components) can be achieved.

In particular, the first and second areas are not separated from each other by separating devices of any kind, so that such an arrangement can be used in particular when corresponding first and second gases or gas mixtures can be continuously fed past the corresponding elements. A concentration gradient can be maintained by a continuous feed and withdrawal taking place in this case, whereas an intermittent feed may rather lead to a mixing over time. Therefore, this embodiment of the invention is advantageously used in the former cases.

In addition or alternatively to the embodiment with separate feed just explained, at least part of the first gas or gas mixture and at least part of the second gas or gas mixture can be fully or partially premixed outside the reactor vessel and fed into the reactor vessel in the fully or partially premixed state. Such an embodiment is particularly suitable for cases in which the reactor vessel does not have a continuous flow. With this alternative interconnection, concentration gradients within the large-volume reactor vessel can be minimized, particularly in the case of distributed metering at the bottom and/or side walls and/or ceiling of the reactor vessel. The advantage of a targeted oxygen enrichment in the area of the heating elements, which is possible with the previously explained design, is traded off in this case for a significantly more homogeneous distribution and a reduced risk of unfavorable local imbalances (e.g. locally too little oxygen at some heating elements or too high oxygen concentrations near the reaction tubes).

A combination of corresponding measures is also possible, for example a separate feed of premixed and non-premixed gas. In this case, for example, a nitrogen-air mixture can be fed in at the wall of the reactor vessel, while nitrogen can be fed in at the center of the reactor vessel. In this way, too, moderate oxygen enrichment can be achieved in the vicinity of the heating elements and, at the same time, the concentration gradients can be limited by the partial premixing.

In principle, in the various embodiments of the invention, a feed can be made into the reactor vessel at a wide variety of locations and, in particular, at multiple points.

The first gas or gas mixture may be or comprise air, a gas mixture enriched or depleted in oxygen relative to air, or oxygen, and the second gas or gas mixture may be or comprise a gas mixture depleted in oxygen relative to air, nitrogen, carbon dioxide, or other inert gas. In principle, the first gas or gas mixture may comprise oxygen in a volume fraction greater than 1%, 5%, 10%. Known processes, for example air separation, can be used to provide corresponding gases or gas mixtures. The term “inert gas” is understood here to mean a gas which, particularly under the conditions prevailing in the reactor vessel, does not participate as a reactant in an oxidative reaction. As mentioned, only one gas or gas mixture can also be fed in, which then has in particular the composition just explained for the second gas or gas mixture.

In all cases, an actual volume fraction of oxygen in at least one area of the reactor vessel can be detected during and/or at the beginning of the reaction period, and a feed of the one or more gases or gas mixtures used to provide the gas atmosphere can be regulated or controlled on the basis of the detection, in particular by a relative and/or absolute change in quantity. The detection can be carried out in particular in a predetermined cycle or (pseudo-)continuously.

In the embodiments of the invention in which there is a continuous flow through the reactor vessel, a detection of the oxygen content can preferably be carried out downstream of the discharge from the reactor vessel (e.g. in the stack or a bypass line and the like). Additionally or alternatively, the oxygen content can be measured at one or more locations within the reactor vessel. Any suitable method of measuring oxygen content can be used, e.g. tunable laser diodes, zirconium oxide probes, gas chromatography, paramagnetic, and the like.

In the case of intermittent pressurization of the reactor vessel, the oxygen content can be measured analogously in a corresponding purge gas discharge line and/or in the reactor vessel itself.

In all embodiments of the invention, if the oxygen concentration exceeds the permitted maximum level, safety relevant functions of any kind can be initiated. If the oxygen level falls below the permitted minimum level, operating measures may be initiated to re-establish the desired oxygen content in the reactor. A too low oxygen concentration is not regarded as a safety concern but can impact heating element life, as mentioned.

An impermissible escape of gas from the reaction tubes can also be detected, in particular via pressure measurement sensors in the reactor vessel. In this way, for example, an injection of reactants can be immediately prevented or halted on the basis of a corresponding switching signal.

To detect minor damage to the reaction tubes (leakage flow without drastic or measurable pressure increase), the content of one or more reactants (especially as carbon monoxide equivalent) can also be measured continuously in the purge flow. An impermissible value can also trigger the rapid shutdown of the reactant feed.

If suitable measuring methods are used (e.g. laser, gas chromatography), the content of hydrocarbons or their combustion products, for example, can also be measured additionally or alternatively with the same sensors in the area of the reactor vessel for all the designs described.

In embodiments of the invention, leak detection may particularly be realized via the presence of moisture, as the reaction tubes typically contain significant quantities of steam.

Thus, more generally, the invention may comprise determining, based on a pressure and/or hydrocarbon measurement and/or a detection of moisture, a value indicative of a gas leak from the one or more reaction tubes, and initiating one or more safety measures when the value exceeds a predetermined threshold.

Further, in certain embodiments, the invention provides means for effecting possible preheating of the conditioning gas(es) prior to free flow into the reactor vessel. Such preheating can particularly be performed in heat exchange with gas withdrawn from the reactor chamber.

In other words, a gas or gas mixture, or at least one of two or more gases or gas mixtures, used to provide the gaseous atmosphere may be preheated before being fed into the reactor vessel. Embodiments of the invention may include waste heat recovery, particularly including preheating achieved via heat exchange with gas exiting the reactor vessel.

Particularly in the case of near-wall injection of a corresponding gas or gas mixture, it can be advantageous to preheat it, e.g. by first passing it in a pipe passage over a sufficient length through the interior of the coil box, i.e. the reactor vessel, before it is then directed to an injection device. In this way, it can be avoided that an unfavorable cooling of the heating elements by a cooler conditioning gas occurs, which could possibly impair the targeted power output of the elements.

It is possible, among other things, that the injection device is located directly at the end of the heated pipe passage, or also that the heated conditioning gas is first led back out of the coil box in a pipeline (preferably in a heat-insulated pipe) and then becomes the injection device from outside. Alternatively, external heat sources can be used to preheat the conditioning gas(es) (electricity, steam, hot oil, hot water and the like).

Thus, the gas injection means used in a corresponding embodiment of the invention may comprise one or more preheating devices and one or more injection devices. An “injection” in this context is intended to refer in particular to the release of the gas or gas mixture into the reactor vessel via corresponding injection devices.

In other words, in a particularly preferred embodiment of the invention, means may be provided to transfer sensible heat in or from an interior of the reactor vessel to the corresponding gas or gas mixture.

The invention further proposes a reactor arrangement for carrying out a chemical reaction comprising a reactor vessel, reaction tubes disposed in the reactor vessel, and means adapted to heat the reaction tubes to a reaction tube temperature level between 400° C. and 1,500° C. during a reaction period using radiant heat provided by means of one or more electrical heating elements disposed in the reactor vessel. It is characterized by means adapted to provide, in at least a part of the reactor vessel in which the heating elements are provided, during the reaction period, a gaseous atmosphere having a volume fraction of oxygen adjusted between a first limit value and a second limit value, the first limit value and the second limit value being chosen as indicated above with respect to the process proposed according to the invention.

For further embodiments of a corresponding reactor arrangement, which may in particular be set up for carrying out a process in any of the embodiments explained above, reference is expressly made to the above explanations.

Features and advantages of the present invention and advantageous embodiments thereof are again explained below.

By the proposed concept of the nearly completely sealed reactor vessel charged with a specific gas atmosphere, the oxygen content can be reduced compared to the ambient air outside. As can be exploited according to the invention, the conversion rate of the exiting hydrocarbons in case of failure of one or more of the reaction tubes and thus the additional volume expansion rate (as a result of the heat of reaction input) correlates in a first approximation with the oxygen partial pressure. This correlation is summarized in Table 1 below, where xO₂ is the oxygen mole fraction and Vᵣₑₐₖ is the reaction-related volume inertia rate. Values indicated below represent an example, not a generally valid quantitative information.

The maximum oxygen content in the reactor vessel (i.e. in particular the second limit value used according to the invention) can be specified in particular on the basis of a dimensioning of an exiting stack.

TABLE 1

| xO₂ [vol. %] | Vᵣₑₐₖ [m³/s] |
|---|---|
| 21 | 218 |
| 15 | 156 |
| 10 | 104 |
| 5 | 52 |
| 3 | 31 |
| 1 | 10 |
| 0.1 (almost inert) | 1 |

The maximum permissible pressure pₘₐₓ in the reaction vessel follows from the mechanical stability of the respective chambers or a surrounding containment. This must be at least as high as the pressure p_{box} in the event of a tube rupture or a corresponding other safety-relevant event, which in turn depends on the volume V_{Box} of the chambers involved, the exiting stack diameter D_{stack} and the oxygen mole fraction:

$${p}_{max} \geq {p}_{b o x} = f ( {V}_{B o x} , {D}_{stack} , {xO}_{2} )$$

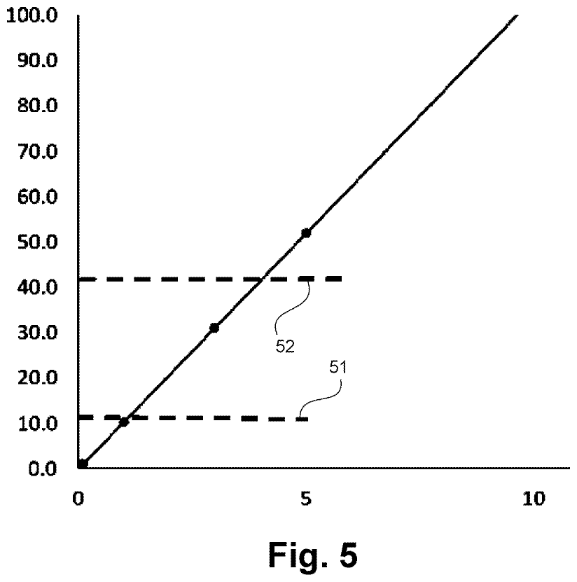

This requirement results in a design basis for the dimensioning of the exiting stack. This relationship will now be explained with reference to FIG. 5. If, for example, a maximum permissible pressure increase of 20 mbar is used as a basis, as illustrated by the dashed lines 51 and 52, a reaction-related volume increase rate of at most approx. 10 m³/s may result in order to be able to use a stack with a diameter of 500 mm (dashed line 51), which leads to a maximum oxygen content of approx. 1%. Looking at it the other way round, if one wants to use a maximum oxygen content of 1%, one must therefore use a stack diameter of at least 500 mm.

In order to be able to use a 900 mm diameter stack (dashed line 52), there must be a volume rate of no more than approx. 42 m³/s, resulting in a maximum oxygen content of approx. 4%. Conversely, and analogously to the explanations above, if a maximum oxygen content of 4% is to be used, a stack diameter of at least 900 mm must therefore be used.

The smaller the oxygen content in the reactor vessel, the smaller the increase in volume. Consequently, the diameter of the exiting stack, which has to dissipate the additional volume, can also be smaller. The decisive factor for efficient limitation of the oxygen content is always a sufficiently good seal against the environment in order to prevent or minimize the uncontrolled entry of oxygen-containing air in a sufficient manner, especially under subatmospheric pressure conditions in the interior of the reactor vessel. As explained, however, complete sealing is not required in this case.

The invention is further explained below with reference to the accompanying drawings, which illustrate embodiments of the invention with reference to and in comparison with the prior art.

In the figures, structurally or functionally corresponding elements are illustrated with identical reference signs and are not explained repeatedly for the sake of clarity. If components of devices are explained below, the corresponding explanations also refer in each case to the processes carried out with them and vice versa.

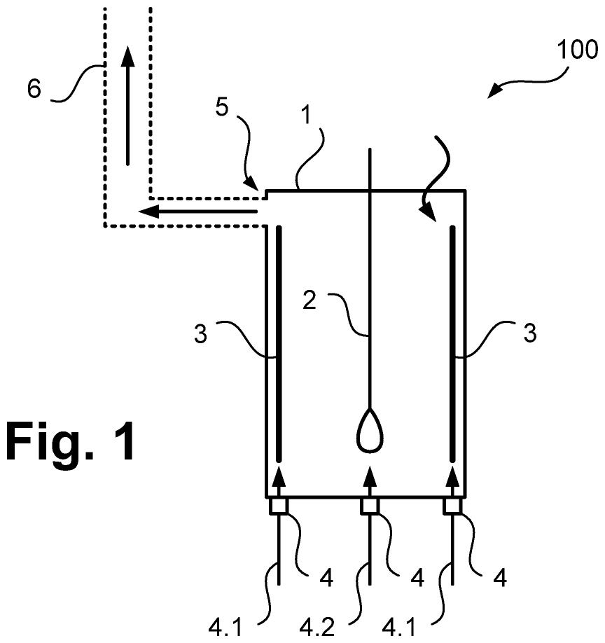

In a reactor arrangement illustrated in FIG. 1 and designated overall as 100, reaction tubes 2, illustrated in greatly simplified form and designed in the manner mentioned above, are arranged in a reactor vessel 1 also designed as explained above. Heating elements 3 of the type also explained are arranged on the wall of the reactor vessel 1, which heat the reaction tubes 2 indirectly and using radiant heat.

In the illustrated example, gas feed means 4 are arranged at the bottom of the reactor vessel 3, by means of which gases or gas mixtures with different oxygen contents can be fed in, as illustrated here with arrows 4.1 and 4.2. In the embodiment illustrated here, these gases or gas mixtures are fed in separately, whereby, in order to provide a higher oxygen content in the region of the heating elements 3, in particular a gas or gas mixture 4.1 with a higher oxygen content than that of a gas or gas mixture 4.2 can be fed in in the region of the reaction tubes 2.

By means of gas extraction means 5, here in the form of a permanently open stack opening to a stack 6, a continuous flow through the reactor vessel 1 with the previously explained advantages can be achieved with simultaneous feed via the gas feed means 4. The reactor vessel 1 can thereby be operated at a sub-atmospheric pressure level due to the lower density of the hot gas atmosphere in the stack compared to the ambient air. The inlet of air is illustrated with an unlabeled curved arrow.

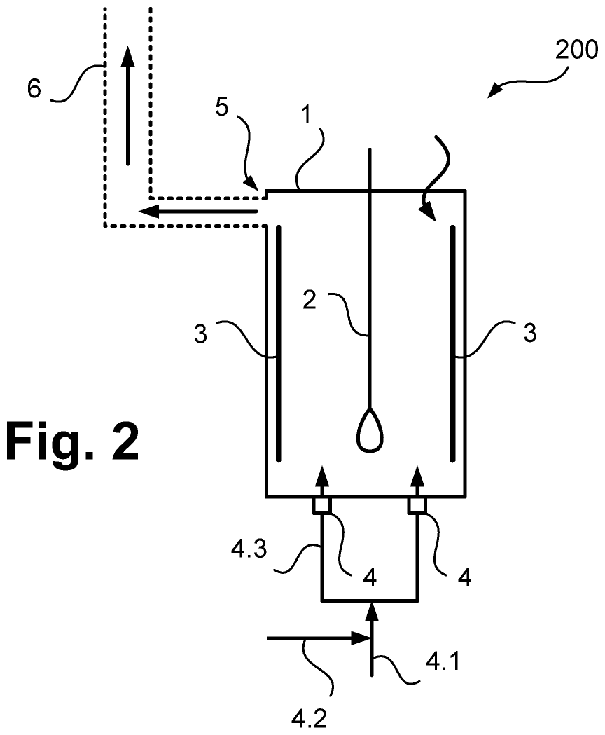

A reactor arrangement 200 illustrated in FIG. 2 differs from this essentially in that the gases or gas mixtures 4.1 and 4.2 are already mixed externally to form a gas mixture 4.3, which is fed into the reactor vessel 1 by means of the gas feed means 4.

As previously explained, all of the embodiments shown can also be operated or provided with the feed of only a single gas or gas mixture, either temporarily or permanently.

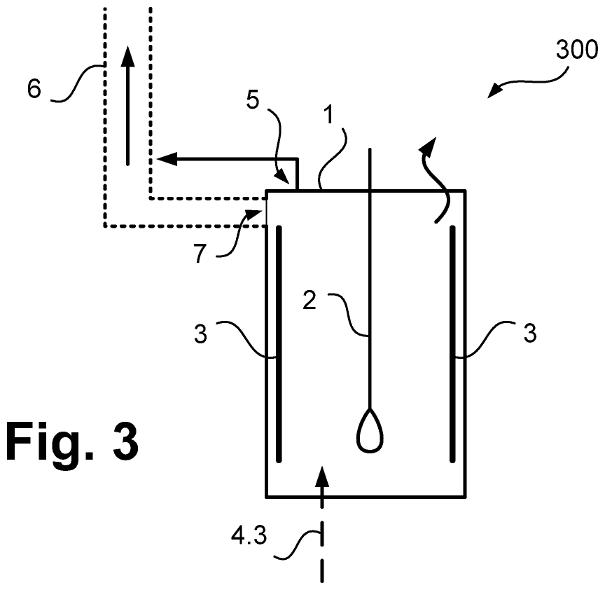

A reactor arrangement 300 illustrated in FIG. 3 differs from the previously explained designs in that a stack opening is closed by means of a bursting disc 7 or another suitable means which only opens the stack cross-section when a certain reactor vessel pressure is exceeded. Gas extraction means, also designated here as 5, establish a bypass connection to the stack 6, which in particular can be appropriately regulated and/or dimensioned. In this way, with the advantages explained, a superatmospheric pressure level can be set in the reactor vessel 1. The gas or gases used to provide the desired oxygen content in the reactor vessel 1 can be premixed or fed separately, as indicated here by a dashed arrow 4.3 for illustrative purposes. An undetermined gas loss from the reactor vessel 1 is shown with a curved arrow.

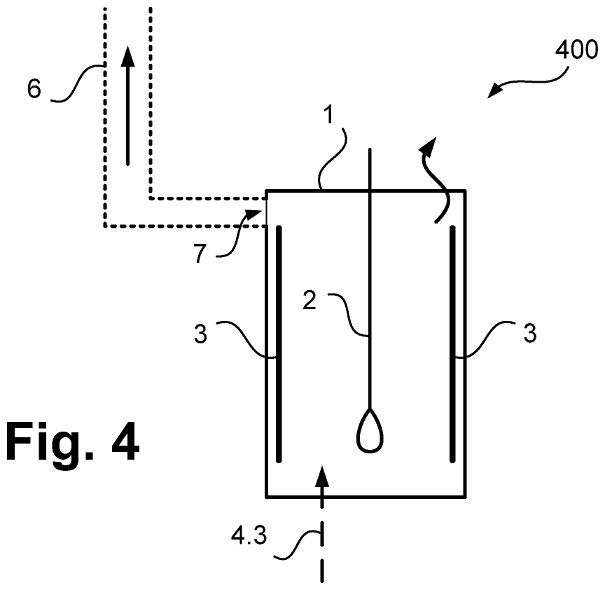

In a further embodiment of a reactor arrangement 400, which is illustrated in FIG. 4, does not comprise any permanently open gas extraction means, so that no flow-through can be set here and the reactor vessel 1 can preferably be pressurized with an appropriate gas atmosphere at the beginning or in regular time intervals. As before, the reactor vessel 1 is operated in particular at a superatmospheric pressure level.

FIG. 5 schematically illustrates basic principles of stack dimensioning according to one embodiment of the invention in the form of a diagram in which an oxygen content in percent is shown on the abscissa and a reaction-related volume inaccuracy rate in ^{m3/s} is shown on the ordinate. A graph 51 represents the relationship already explained above with reference to Table 1. A dashed line 52 denotes values required for a maximum pressure increase of 20 mbar for a stack diameter of 500 mm, and a dashed line 53 denotes corresponding values for a stack diameter of 900 mm. Express reference is made to the above explanations.

FIGS. 6A to 6D schematically illustrate examples of pressure flap arrangements according to embodiments of the invention. As mentioned before, the flap arrangements are configured to close or partially close rectangular openings in a reactor wall, but circular openings in a reactor wall or openings shaped differently may be provided with such flap arrangements as well.

In each case, the flap arrangements include a first flap 601 and a second flap 602. While in the embodiments shown in FIG. 6A, these flaps 601, 602 are shaped to leave a circular opening 603 to allow a defined gas flow in a closed state, they may also be provided, according to the embodiments shown in FIGS. 6B and 6D, in a size leaving a slit-like opening 604 for the same purpose. In the embodiment shown in FIG. 6C, further openings 605 are provided for the same purpose.

Flaps 601, 602 may be hingedly connected to parts of the reactor wall, and they may be provided in a spring or weight biased configuration. According to the embodiments shown in FIGS. 6C and 6D, the flaps 601, 602 themselves may be provided, as indicated with 606, with hinges or, in other embodiments, predetermined breaking lines or notches. These, or a force of a biasing spring or weight may be configured such that the flaps 601, 602 will open above a predetermined pressure.

1. A method for carrying out a chemical reaction using a reactor arrangement, comprising:
heating reaction tubes arranged in a reactor vessel from the outside during a reaction period to a reaction tube temperature level between 400° C. and 1,500° C. using radiation heat which is provided by means of one or more electric heating elements which are provided in the reactor vessel; and
passing one or more flammable components through the reaction tubes during the reaction period;
wherein, in at least a part of the reactor vessel in which the heating elements are provided, a gaseous atmosphere is provided during the reaction period or during a part of the reaction period, wherein the gaseous atmosphere comprises a volume fraction of oxygen between 500 ppm and 10% in addition to one or more known inert gases or one or more noble gases, wherein the volume fraction of oxygen prevails where the heating elements are arranged in the reactor vessel.

2. The method according to claim 1, wherein the gaseous atmosphere comprises a volume fraction of oxygen between 1,000 ppm and 5% or between 5,000 ppm and 3%.

3. The method according to claim 2, further comprising performing a continuous or discontinuous feed of one or more gases or gas mixtures used to provide the gas atmosphere to, and/or a removal of at least part of the gas atmosphere from, the reactor vessel.

4. The method according to claim 3, wherein a sub-atmospheric pressure level is provided in the reactor vessel.

5. The method according to claim 1, wherein a superatmospheric pressure level is provided in the reactor vessel.

6. The method according to claim 1, wherein a wall of the reactor vessel does not comprise inspection ports for visual inspection of an inner space of the reactor vessel or only comprises inspection ports for visual inspection of the inner space of the reactor vessel which are gas-tightly closed by a transparent material.

7. The method according to claim 1, wherein one, two, or more gases or gas mixtures are used to provide the gas atmosphere.

8. The method according to claim 7, wherein two or more gases or gas mixtures are used comprising a first gas or gas mixture having a first volume fraction of oxygen and a second gas or gas mixture having a second volume fraction of oxygen below the first volume fraction.

9. The method according to claim 8, wherein at least a portion of the first gas or gas mixture is fed into at least a first region of the reactor vessel, and wherein at least a portion of the second gas or gas mixture is fed separately therefrom into at least a second region of the reactor vessel.

10. The method of claim 2, wherein a gas or gas mixture is used that is injected into a second region of the reactor vessel while no gas or gas mixture is injected into a first region of the reactor vessel.

11. The method according to claim 10, wherein the heating elements are arranged in the at least one first region and the reaction tubes are arranged in the at least one second region of the reactor vessel.

12. The method according to claim 7, wherein at least a portion of the first gas or gas mixture and at least a portion of the second gas or gas mixture are mixed outside the reactor vessel and are fed into the reactor vessel in a mixed state.

13. The method according to claim 2, in which, during and/or at the beginning of the reaction period, an actual volume fraction of oxygen is detected in at least one region of the reactor vessel and/or stack, bypass or purge lines connected thereto, and a feed of the one or more gases or gas mixtures used to provide the gas atmosphere is regulated or controlled on the basis of the detection.

14. The method according to claim 2, wherein the gas or gas mixture, or at least one of the two or more gases or gas mixtures, used to provide the gas atmosphere is or are preheated prior to injection into the interior of the reactor vessel.

15. A reactor arrangement for carrying out a chemical reaction, comprising:
a reactor vessel,
reaction tubes arranged in the reactor vessel;
means arranged to heat the reaction tubes from the outside during a reaction period to a reaction tube temperature level between 400° C. and 1,500° C. using radiant heat provided by means of one or more electric heating elements arranged in the reactor vessel; and
means adapted to provide, in at least a part of the reactor vessel in which the heating elements are provided, during the reaction period or a part of the reaction period, a gaseous atmosphere;
wherein:
the gaseous atmosphere comprises a volume fraction of oxygen between 500 ppm and 10% in addition to one or more known inert gases or one or more noble gases; and
the volume of oxygen prevails in the areas where the heating elements are arranged.

16. The reactor arrangement according to claim 15, wherein the gaseous atmosphere comprises a volume fraction of oxygen between 1,000 ppm and 5% or between 5,000 ppm and 3%.

17. The reactor arrangement according to claim 5, wherein a superatmospheric pressure level is provided in the reactor vessel.

18. The method according to claim 1, further comprising performing a continuous or discontinuous feed of one or more gases or gas mixtures used to provide the gas atmosphere to, and/or a removal of at least part of the gas atmosphere from, the reactor vessel.

19. The method according to claim 18, wherein a sub-atmospheric pressure level is provided in the reactor vessel.

20. The method according to claim 9, wherein the heating elements are arranged in the at least one first region and the reaction tubes are arranged in the at least one second region of the reactor vessel.
